(19) United States
(12) Patent Application Publication
(10) Pub. No.: US 2025/0188321 A1
(43) Pub. Date: Jun. 12, 2025

(54) FIRE-RETARDANT PRESSURE SENSITIVE ADHESIVES, ARTICLES, AND USES

(71) Applicant: 3M INNOVATIVE PROPERTIES COMPANY, St. Paul, MN (US)

(72) Inventors: Clinton G. Wiener, St. Paul, MN (US); Anna K. Davy, Apple Valley, MN (US); Eumi Pyun, St. Paul, MN (US); Mahfuza B. Ali, Mendonta Heights, MN (US); Dillon S. Gentekos, St. Paul, MN (US)

(21) Appl. No.: 18/687,088

(22) PCT Filed: Aug. 31, 2022
(86) PCT No.: PCT/IB2022/058178

§ 371 Date: Feb. 27, 2024

Related U.S. Application Data
(60) Provisional application No. 63/239,320, filed on Aug. 31, 2021.

(51) Int. Cl. C09J 7/38; C09J 9/00; C09J 11/06

(52) U.S. Cl. CPC C09J 7/385; C09J 9/00; C09J 11/06; C09J 2301/124; C09J 2301/302; C09J 2301/408; C09J 2301/414

(57) ABSTRACT

A fire-retardant pressure sensitive adhesive, article including such adhesive, and uses thereof, wherein the adhesive includes: a (meth)acrylate polymer and a non-halogenated flame retardant. The (meth)acrylate polymer includes interpolymerized monomers comprising: (a) an acid-functional (meth)acrylate monomer; (b) a hydroxy-functional (meth)acrylate monomer; (c) a noncationic nitrogen-containing monomer; and (d) a (meth)acrylate ester of a linear or branched alcohol having 3 to 4 carbon atoms and/or a (meth)acrylate ester of a linear, branched, or cyclic alcohol having 5 to 20 carbon atoms.

### BACKGROUND

Pressure sensitive adhesives are used in a variety of applications where lire risk is a major concern, such as in aircraft, automobiles, trains, ships, building construction (e.g., heating, ventilation, and air conditioning (HVAC) systems), and in conjunction with electronics and electrical wiring.

Flexible ductwork is of particular concern since it is used in HVAC systems all over the world, and it must meet many building specifications, such as R-value, flammability ratings, and vapor permeability, to name a few. Typical HVAC flexible ductwork construction includes an inner core containing a metal coil laminated between layers of clear polyethylene terephthalate (PET). In some constructions, the inner core is then wrapped with fiberglass insulation which is finally wrapped with an outer layer that includes a scrim laminated between a layer of clear PET and metalized PET.

Typical adhesives used in forming the laminates, particularly the outer layer PET laminates, include styrene-butadiene rubbers (SBR's), acrylates, and ethylene-propylene-diene monomer (EPDM) adhesives. Many of these adhesives are inherently flammable. Thus, one of the main difficulties of constructing a thin film PET construction with fire-retardant (FR) properties is the ability to extinguish a flame due solely to the flame inhibiting properties of an adhesive interlayer, which not only counteracts the burning of the adhesive but also the burning of the PET layers.

Historically, in order to achieve the desired flammability ratings (such as UL 181) of adhesives, flame retardants have been added. These reduce the flammnability of materials by a variety of mechanisms, including quenching free radical s in the gas phase, reacting with chemical fragments from the burning material to initiate char formation, and forming barrier layers within the burning material.

One type of flame retardant includes heavy metal, halogenated fire retardants. These fire retardants work particularly well because they work in the gas phase to extinguish the flame. In recent years, the industry has begun investigation of non-heavy metal, non-halogenated flame-retardant agents (i.e., flame retardants) due to toxicity concerns of currently used agents. Unfortunately, however, non-halogenated flame retardants are typically less efficient flame retardants than halogenated materials commonly used.

What is needed is an adhesive that has inherently lower flammability than that of conventional adhesives, particularly those used in flexible ductwork of HVAC constructions, thereby improving the fire-retardant properties of a total formulation with added non-halogenated flame retardants.

### SUMMARY

The present disclosure provides fire-retardant pressure sensitive adhesives and articles (e.g., tapes) that includes such adhesives, as well as uses thereof.

In one embodiment, a fire-retardant pressure sensitive adhesive is provided that includes: a (meth)acrylate polymer and a non-halogenated flame retardant. The (meth)acrylate polymer includes interpolymerized monomers comprising: (a) an acid-functional (meth)acrylate monomer or oligomer thereof; (b) a hydroxy-functional (meth)acrylate monomer or oligomer thereof; (c) a nitrogen-containing monomer or oligomer thereof; and (d) a (meth)acrylate ester of a linear or branched alcohol having 3 to 4 carbon atoms and/or a (meth)acrylate ester of a linear, branched, or cyclic alcohol having 5 to 20 carbon atoms. Preferably, the (meth)acrylate polymer has a glass transition temperature (Tg) of −10° C. or less.

In a more specific embodiment, (meth)acrylate polymer includes interpolymerized monomers comprising: (a) 0.1 part to 30 parts of methacrylic acid, acrylic acid, or a combination thereof and/or 0.1 part to 30 parts of beta-carboxy ethyl acrylate, 2-methacryloyloxyethyl succinate, fumaric acid, an oligomer thereof, or a combination thereof; (b) 0.1 part to 20 parts of 4-hydroxy butyl acrylate, 2-hydroxy ethyl acrylate, hydroxy propyl acrylate, an oligomer thereof, or a combination thereof; (c) 0.1 part to 8 parts of N-vinyl caprolactam, N-vinyl pyrrolidinone, acrylonitrile, dimethyl acrylamide, acrylamide, t-octyl acrylamide, or a combination thereof; (d) 40 parts to 95 parts of n-propyl(meth)acrylate, isopropyl(meth)acrylate, n-butyl(meth)acrylate, isobutyl(meth)acrylate, tert-butyl(meth)acrylate, or a combination thereof and/or 10 parts to 60 parts of n-pentyl(meth)acrylate, iso-pentyl(meth)acrylate, n-hexyl(meth)acrylate, iso-hexyl(meth)acrylate, cyclohexyl(meth)acrylate, phenyl(meth)acrylate, 1-octyl(meth)acrylate, iso-octyl(meth)acrylate, 2-octyl(meth)acrylate, 3-octyl(meth)acrylate, 2-ethylhexyl(meth)acrylate, decyl(meth)acrylate, lauryl(meth)acrylate, 2-propylheptyl(meth)acrylate, stearyl(meth)acrylate, isobornyl(meth)acrylate, benzyl(meth)acrylate, octadecyl(meth)acrylate, nonyl(meth)acrylate, dodecyl(meth)acrylate, isophoryl(meth)acrylate, or a combination thereof; wherein the amount of each monomer is based on the total amount of the interpolymerized monomers (and the total amount of interpolymerized monomers includes 100 parts).

Also provided is an adhesive article (e.g., tape) comprising an adhesive layer that includes the fire-retardant pressure sensitive adhesive described herein and a supporting layer.

Herein, a “fire-retardant” pressure sensitive adhesive is one that delays, and preferably, stops, a fire from spreading. Preferably, a “fire-retardant” pressure sensitive adhesive is one in which a sample prepared and tested according to the Burn Test described in the Examples Section, which is modeled after the burning portion of UL-181 standard procedure for flexible air ducts, wherein after applying the flame for 1 minute to a test sample, the flame should self-extinguish within 60 seconds and not spread to the farthest point of the sample from application of the flame.

A variety of methods can be used to identify a pressure sensitive adhesive of the present disclosure. A well-known definition of a suitable pressure sensitive adhesive is that it preferably has a room temperature storage modulus within the area defined by the following points as plotted on a graph of modulus versus frequency at 25° C.: a range of moduli from approximately 2×10⁵ to 8×10⁵ dynes/cm² at a frequency of approximately 0.1 radian/second (0.017 Hz), and a range of moduli from approximately 2×10⁶ to 8×10⁶ dynes/cm² at a frequency of approximately 100 radians/second (17 Hz) (for example, see FIG. 8-16 on p. 173 of Handbook of Pressure Sensitive Adhesive Technology (Donatas Satas, Ed.), 2^{nd} Edition, Van Nostrand Rheinhold, New York, 1989).

The term “(meth)acrylate” includes acrylate and methacrylate monomers, polymers derived from these monomers, or both. Likewise, the term “(meth)acrylic acid includes acrylic acid and methacrylic acid.

The term “glass transition temperature” or “Tg” refers to the temperature at which a material changes from a glassy state to a rubbery state, In this context, the term “glassy means that the material is hard and brittle (and therefore relatively easy to break) while the term “rubbery” means that the material is elastic and flexible, For polymeric materials, the Tg is the critical temperature that separates their glassy and rubbery behaviors. If a polymeric material is at a temperature below its Tg, large-scale molecular motion is severely restricted because the material is essentially frozen. On the other hand, if the polymeric material is at a temperature above its Tg, molecular motion on the scale of its repeat unit takes place. allowing it to be soft or rubbery. The glass transition temperature of a polymeric material is a rheology Tg as determined by the Glass Transition Temperature Test in the Examples Section.

The value of Tg of the monomers used to estimate the polymer Tg are based on literature (e.g., trade literature) values. Typically, there is some variation of the Tg values of the homopolymers of monomers listed in such literature. The difference arises from the test method used to measure the Tg and molecular weight of the polymer species. The differences also arise from influence of comonomers polymerized together. Alternatively, the method of determining the Tg of a homopolymer can be determined using a DSC procedure.

The terms “polymer” and “polymeric material” include, but are not limited to, organic homopolymers, copolymers, such as for example, block, graft, random and alternating copolymers, terpolymers, etc., and blends and modifications thereof. Furthermore, unless otherwise specifically limited, the term “polymer” shall include all possible geometrical configurations of the material. These configurations include, but are not limited to, isotactic, syndiotactic, and atactic symmetries.

Herein, the term “comprises” and variations thereof do not have a limiting meaning where these terms appear in the description and claims. Such terms will be understood to imply the inclusion of a stated step or element or group of steps or elements but not the exclusion of any other step or element or group of steps or elements. By “consisting of” is meant including, and limited to, whatever follows the phrase “consisting of.” Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they materially affect the activity or action of the listed elements. Any of the elements or combinations of elements that are recited in this specification in open-ended language (e.g., comprise and derivatives thereof), are considered to additionally be recited in closed-ended language (e.g., consist and derivatives thereof) and in partially closed-ended language (e.g., consist essentially, and derivatives thereof).

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the disclosure.

In this application, terms such as “a,” “an,” and “the” are not intended to refer to only a singular entity, but include the general class of which a specific example may be used for illustration. The terms “a,” “an,” and “the” are used interchangeably with the term “at least one.” The phrases “at least one of” and “comprises at least one of” followed by a list refers to any one of the items in the list and any combination of two or more items in the list.

As used herein, the term “or” is generally employed in its usual sense including “and/or” unless the content clearly dictates otherwise.

The term “and/or” means one or all of the listed elements or a combination of any two or more of the listed elements.

Also herein, all numbers are assumed to be modified by the term “about” and in certain embodiments, preferably, by the term “exactly.” As used herein in connection with a measured quantity, the term “about” refers to that variation in the measured quantity as would be expected by the skilled artisan making the measurement and exercising a level of care commensurate with the objective of the measurement and the precision of the measuring equipment used. Herein, “up to” a number (e.g., up to 50) includes the number (e.g., 50).

Also herein, the recitations of numerical ranges by endpoints include all numbers subsumed within that range as well as the endpoints (e.g., 1 to 5 includes 1, 1.5, 2, 2.75, 3, 3.80, 4, 5, etc.).

As used herein, the term “room temperature” refers to a temperature of 22° C. to 25° C.

The term “in the range” or “within a range” (and similar statements) includes the endpoints of the stated range.

Reference throughout this specification to “one embodiment,” “an embodiment,” “certain embodiments,” or “some embodiments,” etc., means that a particular feature, configuration, composition, or characteristic described in connection with the embodiment is included in at least one embodiment of the invention. Thus, the appearances of such phrases in various places throughout this specification are not necessarily referring to the same embodiment of the invention. Furthermore, the particular features, configurations, compositions, or characteristics may be combined in any suitable manner in one or more embodiments.

The above summary of the present disclosure is not intended to describe each disclosed embodiment or every implementation of the present invention. The description that follows more particularly exemplifies illustrative embodiments. In several places throughout the application, guidance is provided through lists of examples, which examples may be used in various combinations. In each instance, the recited list serves only as a representative group and should not be interpreted as an exclusive list. Thus, the scope of the present disclosure should not be limited to the specific illustrative structures described herein, but rather extends at least to the structures described by the language of the claims, and the equivalents of those structures. Any of the elements that are positively recited in this specification as alternatives may be explicitly included in the claims or excluded from the claims, in any combination as desired. Although various theories and possible mechanisms may have been discussed herein, in no event should such discussions serve to limit the claimable subject matter.

### BRIEF DESCRIPTION OF FIGURES

FIG. 1 is a schematic (not necessarily shown to scale) of a sample showing overlap, prepared with both PET layers, overlap size, and scrim between adhesive coated surfaces of the PET.

FIG. 2 is a black and white photograph of the burn test results for Examples 1 and 2.

FIG. 3 is a black and white photograph of the burn test results for Examples 2-4.

FIG. 4 is a black and white photograph of the burn test results for Examples 5-7.

FIG. 5 is a black and white photograph of the burn test results for Examples 8-11 and two commercially available comparative samples.

FIG. 6 is a black and white photograph of the burn test results of Example 8 and a commercially available comparative example.

### DETAILED DESCRIPTION

The present disclosure provides fire-retardant pressure sensitive adhesives and articles (e.g., tapes) that includes such adhesives, as well as uses thereof.

In one embodiment, a fire-retardant pressure sensitive adhesive (PSA) is provided that includes: a (meth)acrylate polymer and a non-halogenated flame retardant. The (meth)acrylate polymer includes interpolymerized monomers comprising: (a) an acid-functional (meth)acrylate monomer or oligomer thereof; (b) a hydroxy-functional (meth)acrylate monomer or oligomer thereof; (c) a nitrogen-containing monomer or oligomer thereof; and (d) a (meth)acrylate ester of a linear or branched alcohol having 3 to 4 carbon atoms and/or a (meth)acrylate ester of a linear, branched, or cyclic alcohol having 5 to 20 carbon atoms.

The (meth)acrylate polymer, which is preferably formed from an emulsion polymerization process, contributes to the superior performance of the fire-retardant pressure sensitive adhesive in applications (e.g., for bonding layers within HVAC flexible ductwork) where both strength and halogen-free flame-retardants are desired. That is, the combination of monomers (a), (b), (c), and (d) provides a balance of properties (e.g., good fire-retardant and adhesive properties such as modulus and tack) with a lower amount of added non-halogenated flame retardant than is typically used. Typically, this is no more than 45 wt-%, no more than 40 wt-%, no more than 35 wt-%, or no more than 30 wt-%, of the non-halogenated flame retardant, based on the total weight of the fire-retardant pressure sensitive adhesive. In certain embodiments the flame retardant is a non-halogenated, heavy metal-free compound.

Adhesives of the present disclosure preferably include less than 0.4 wt-% heavy metals (metals with atomic numbers greater than 20) and/or halogens in halogenated hydrocarbons (a compound containing one or more covalently bound halogen atom), if any.

Preferably, the (meth)acrylate polymer has a glass transition temperature (Tg) of −10° C. or less determined as described in the Examples Section. The combination of monomers to form such polymer includes one or more acid-functional monomers, which raise the Tg, and one or more lower Tg, softer monomers (e.g., a hydroxy monomer with a Tg less than 0° C.) than (meth)acrylic acid (e.g., acrylic acid has a homopolymer Tg of 107° C. and methacrylic acid has a homopolymer Tg of 228° C.). Such lower Tg, softer monomers help to balance the Tg and the modulus or the polymer, help to “absorb” the flame retardant without making the PSA too stiff to prevent rapid self adhesion with minimal pressure applied, and contribute to the improved fire retardancy of the PSA.

The selected monomers are typically rich in oxygen and low in carbon, with a preferred oxygen content of greater than 20% by weight (i.e., wt-%), or greater than 25 wt-%, which enhances the fire retardancy properties of the PSA.

In certain embodiments, monomers (a), (b), and (c) are present in a combined amount of at least 8 parts, at least 10 parts, or at least 12 parts (i.e., wt-%), based on the total amount of the interpolymerized monomers. In certain embodiments, monomers (a), (b), and (c) are present in a combined amount of up to 30 parts, up to 25 parts, up to 20 parts, or up to 18 parts, based on the total amount of the interpolymerized monomers.

In certain embodiments, the remainder of the interpolymerized monomers (e.g., at least 60 parts) include a (meth)acrylate ester of a linear or branched alcohol having 3 to 4 carbon atoms (e.g., n-butyl acrylate), a (meth)acrylate ester of linear, branched, or cyclic alcohol having 5 to 20 carbon atoms (e.g., iso-hexyl acrylate), as well as a number of other optional monomers including a stabilizing monomer, a cationic monomer, a crosslinking monomer, or a combination thereof.

### Monomer (a): Acid-Functional (Meth)acrylate Monomer/Oligomer

In certain embodiments, the acid-functional (meth)acrylate monomer is selected from the group consisting of methacrylic acid, acrylic acid, and a combination thereof.

In certain embodiments, the acid-functional (meth)acrylate monomer is a carboxylic acid-functional (meth)acrylate short chain ester monomer or oligomer thereof. Such monomer is preferably selected to have a relatively low homopolymer Tg, preferably a Tg of less than 50° C., or less than 40° C. This allows for a softer polymer and provides acid functionality for lower water solubility. In this context, a “short chain” ester refers to a linear chain having 1 to 6 carbon atoms.

In certain embodiments, the carboxylic acid-functional (meth)acrylate short chain ester monomer or oligomer thereof is selected from the group consisting of beta-carboxy ethyl acrylate, 2-methacryloyloxyethyl succinate, fumaric acid, an oligomer thereof, and a combination thereof.

Oligomers of these monomers are included because lower grades of the short chain acids are typically a mixture of monomers and oligomers.

In certain embodiments, the interpolymerized monomers include at least 0.1 part, at least 0.5 part, or at least 1 part of methacrylic acid, acrylic acid, or a combination thereof, based on the total amount of the interpolymerized monomers. In certain embodiments, the interpolymerized monomers include up to 30 parts, up to 20 parts, up to 10 parts, up to 8 parts, up to 6 parts, up to 5 parts, or up to 4 parts of methacrylic acid, acrylic acid, or a combination thereof, based on the total amount of the interpolymerized monomers.

In certain embodiments, the interpolymerized monomers include at least 0.1 part, at least 0.5 part, or at least 1 part of the carboxylic acid-functional (meth)acrylate short chain ester monomer or oligomer thereof, based on the total amount of the interpolymerized monomers. In certain embodiments, the interpolymerized monomers include up to 30 parts, up to 20 parts, up to 10 parts, up to 8 parts, up to 6 parts, up to 5 parts, or up to 4 parts of the carboxylic acid-functional short chain ester monomer or oligomer thereof, based on the total amount of the interpolymerized monomers.

Monomer (b): Hydroxy-functional (Meth)acrylate Monomer A hydroxy-functional (meth)acrylate monomer is selected to have an oxygen content of greater than 25 wt-% (e.g., hydroxybutyl acrylate has an oxygen content of 33.3 wt-%, hydroxypropyl acrylate has an oxygen content of 36.9 wt-%, and hydroxyethyl acrylate has an oxygen content of 41.3 wt-%).

The hydroxy-functional monomer adds stability to an emulsion while adding oxygen-rich side chains, which improves fire retardancy and produces higher residual unburned material/char in the burn area.

In certain embodiments, the hydroxy-functional (meth)acrylate monomer is selected from the group consisting of 4-hydroxy butyl acrylate, 2-hydroxy ethyl acrylate, hydroxy propyl acrylate, and oligomer thereof, and a combination thereof.

In certain embodiments, the interpolymerized monomers include at least 0.1 part, at least 0.5 part, or at least 1 part of the hydroxy-functional monomer, based on the total amount of the interpolymerized monomers. In certain embodiments, the interpolymerized monomers include up to 20 parts, up to 15 parts, up to 10 parts, up to 8 parts, or up to 6 parts of the hydroxy-functional monomer, based on the total amount of the interpolymerized monomers.

Monomer (c): Non-cationic Nitrogen-Containing Monomer A non-cationic nitrogen-containing monomer is selected to have an oxygen content of greater than 20 wt-% (e.g., N-vinyl caprolactam has an oxygen content of 21.5 wt-%).

In certain embodiments, the non-cationic nitrogen-containing monomer is selected from the group consisting of N-vinyl caprolactam, N-vinyl pyrrolidinone, acrylonitrile, dimethyl acrylamide, acrylamide, t-octyl acrylamide, and a combination thereof.

In certain embodiments, the interpolymerized monomers include at least 0.1 part, at least 0.5 part, or at least 1 part of the non-cationic nitrogen-containing monomer, based on the total amount of the interpolymerized monomers. In certain embodiments, the interpolymerized monomers include up to 8 parts, up to 6 parts, up to 4 parts, or up to 2 parts of the non-cationic nitrogen-containing monomer, based on the total amount of the interpolymerized monomers.

Monomer (d): (Meth) Acrylate Ester of a Linear or Branched Alcohol Having 3-4 Carbon Atoms and/or (Meth) Acrylate Ester of a Linear, Branched, or Cyclic Alcohol Having 5-20 Carbon Atoms

In certain embodiments, the interpolymerized monomers include a (meth)acrylate ester of a linear or branched alcohol having 3 to 4 carbon atoms. In certain embodiments, such monomer is selected from the group consisting of n-propyl(meth)acrylate, isopropyl(meth)acrylate, n-butyl(meth)acrylate, isobutyl(meth)acrylate, tert-butyl(meth)acrylate, and a combination thereof. Preferably, such monomer is n-butyl acrylate.

In certain embodiments, the interpolymerized monomers include at least 40 parts of the (meth)acrylate ester of a linear or branched alcohol having 3 to 4 carbon atoms, based on the total amount of interpolymerized monomers. In certain embodiments, the interpolymerized monomers include up to 95 parts of the (meth)acrylate ester of a linear or branched alcohol having 3 to 4 carbon atoms, based on the total amount of interpolymerized monomers.

In certain embodiments, the interpolymerized monomers include a (meth)acrylate ester of a linear, branched, or cyclic alcohol having 5 to 20 carbon atoms. In certain embodiments, such monomer is selected from the group consisting of n-pentyl(meth)acrylate, iso-pentyl(meth)acrylate, n-hexyl(meth)acrylate, iso-hexyl(meth)acrylate, cyclohexyl(meth)acrylate, phenyl(meth)acrylate, 1-octyl(meth)acrylate, isooctyl(meth)acrylate, 2-octyl(meth)acrylate, 3-octyl(meth)acrylate, 2-ethylhexyl(meth)acrylate, decyl(meth)acrylate, lauryl(meth)acrylate, 2-propylheptyl(meth)acrylate, stearyl(meth)acrylate, isobornyl(meth)acrylate, benzyl(meth)acrylate, octadecyl(meth)acrylate, nonyl(meth)acrylate, dodecyl(meth)acrylate, isophoryl(meth)acrylate, and a combination thereof. Preferably, such monomer is iso-hexyl acrylate.

In certain embodiments, the interpolymerized monomers include at least 10 parts of the (meth)acrylate ester of a linear, branched, or cyclic alcohol having 5 to 20 carbon atoms, based on the total amount of interpolymerized monomers. In certain embodiments, the interpolymerized monomers include up to 60 parts of the (meth)acrylate ester of a linear, branched, or cyclic alcohol having 5 to 20 carbon atoms, based on the total amount of interpolymerized monomers.

### Optional Stabilizing Monomer

In certain embodiments, the interpolymerized monomers may include a low molecular weight stabilizing monomer comprising an ethylenically unsaturated ester monomer.

In this context, “low molecular weight” means a molecular weight of less than 125 g/mol, or less than 110 g/mol.

In certain embodiments, the low molecular weight stabilizing monomer is selected from the group consisting of vinyl acetate, methyl acrylate, ethyl acrylate, methyl methacrylate, and a combination thereof.

In certain embodiments, if it is present, the interpolymerized monomers include at least 0.1 part, at least 0.5 part, or at least 1 part of the stabilizing monomer, based on the total amount of the interpolymerized monomers. In certain embodiments, if it is present, the interpolymerized monomers include up to 5 parts of the stabilizing monomer, based on the total amount of the interpolymerized monomers.

### Optional Cationic Monomer

In certain embodiments, the interpolymerized monomers may include a cationic monomer. In certain embodiments, the cationic monomer is a cationic quaternary amine, such as DMAEA-MCL (N,N-dimethylaminoethyl acrylate methyl chloride quaternary, 80% in water, obtained under the trade designation “AGEFLEX FA1Q80MC” from BASF SE, Ludwigshafen, Germany).

In certain embodiments, if present, the interpolymerized monomers include at least 0.1 part, at least 0.5 part, or at least 1 part of the cationic monomer, based on the total amount of the interpolymerized monomers. In certain embodiments, if present, the interpolymerized monomers include up to 8 parts, up to 6 parts, up to 4 parts, or up to 2 parts of the cationic monomer, based on the total amount of the interpolymerized monomers.

### Optional Crosslinking Monomer

In certain embodiments, the interpolymerized monomers include a crosslinking monomer. In certain embodiments, the crosslinking monomer is a polyfunctional monomer, such as those selected from polyvinyls or poly(meth)acrylates (e.g., 1,6-hexanediol diacrylate).

In certain embodiments, if present, the interpolymerized monomers include no more than 0.5 wt-% crosslinker, based on the total amount of the interpolymerized monomers.

### Emulsion or Suspension Polymerization

Standard techniques of making an emulsion or suspension polymer may be used. The mode of emulsion or stuspensionpolymerization is not particularly limited. Emulsion polymerzation is preferred. There is no required order of mixing monomers or required combination of monomers. Standard methods, polymerization conditions (polymerization temperature, polymerization time, polymerization pressure, etc.), and materials (polymerization initiator, surfactant etc.) can be used as is kno wn by one of skill in the art. For example, the entire monomer mixture may be supplied at once to a reaction vessel, or gradually fed, or divided into several portions and supplied at different times during the polymerization process.

A water-soluble polymerization initiator can be used in the emulsion polymerization process. Examples include azo initiators, e.g., 2,2′-azobis isobutyronitrile, 2,2″-azobis(2-methylpropioiinidine)disulfate. 2,2-azobis(2-amidinopropane)dihydrochloride, 2,2′-azobis[2-(5-methyl-2-imidazolin-2-yl)propanejdihydrochloride, 2,2′-azobis(N,N′-dimethylene isobutyl amidine)dihydrochloride, and 2,2-azobis[N-(2-carboxyethyl)-2-methyl propionamidine]hydrate, etc.; persulfates such as potassium persulfate, ammonium persulfate, etc.; peroxide initiators such as benzoyl peroxide, t-butyl bydroperoxide, hydrogen peroxide. etc.; redox initiators wherein a peroxide and a reducing agent are combined such as a combination of a persulfate and sodium hydrogen sulfite, a combination of a peroxide and sodium ascorbate, etc.; and the like, but these examples are not limited thereto. The amount of polymerization initiator to be used can be suitably selected in accordance with the type of initiator, types of monomers (formula of the monomer starting material), and the like. Typically, 0.01 to 1 part per one hundred parts of the monomer starting material will be appropriate. A batch process wherein essentially all of the polymerization initiator to be used is placed in the reaction vessel (typically, an aqueous solution of the polymerization initiator) before starting the feed of monomer-containing material, a continuous process, or a semi-batch process can all be used as the method of supplying the polymerization initiator. The polymerization temperature can be set, for example, at 20° C. to 100° C. (preferably, 40° C. to 90° C.).

In certain embodiments, the (meth)acrylate polymer is formed from components that also include one or more radical transfer agents (i.e., chain transfer agents), although such agent is not required in certain situations. A chain transfer agent can be one or more types selected from the following: mercaptans such as pentaerythritol tetrakis(3-mercaptopropionate) (PTMP), n-dodecyl mercaptan (dodecanethiol), tert-dodecyl mercaptan (dodecanethiol), glycidyl mercaptan, 2-mercapto ethanol, mercaptoacetic acid, 2-ethylhexyl thioglycolate (EHTL), and 2,3-dimercapto-1-propanol, etc.; an alpha-methyl styrene dimer; and a terpene such as alpha-pinene, limonene, terpinol, etc. One type can be used alone or two or more types thereof can be used in combination. A preferred chain transfer agent is EHTL because it has lower odor compared with some chain transfer agents (e.g., t-dodecyl mercaptan). The amount of chain transfer agent used can be, for example, 0.001 to 1 part by weight, and normally 0.005 to 0.8 part by weight is preferred, relative to 100 parts by weight of monomer starting material.

In certain embodiments, the (meth)acrylate emulsion polymer is formed from components that also include one or more surfactants. Surfactants may be nonionic, cationic, or anionic. Exemplary nonionic surfactants include, but are not limited to, polymerizable nonionic surfactants (e.g., polyoxyethylene alkylphenyl ethers available under the tradename NOIGEN RN from Montello, Tulsa, OK) or nonpolymerizable nonionic surfactants (e.g., alkyl phenol ethoxylates, octylphenol ethoxylates, and nonylphenol ethoxylates available under the tradename IGEPAL from Solvay, IL or C9C11-Alkyl Polyglucosides such as APG 325N from BASF NJ). Exemplary cationic surfactants include, but are not limited to, quaternary ammonia compounds with positively charged surface-active moieties (e.g., benzalkonium, benzethonium, methylbenzethonium, cetylpyridinium, alkyl-dimethyl dichlorobenzene ammonium, dequalinium and phenamylinium chloridies, cetrimonium and cetrhexonium bromides), as well as the following:

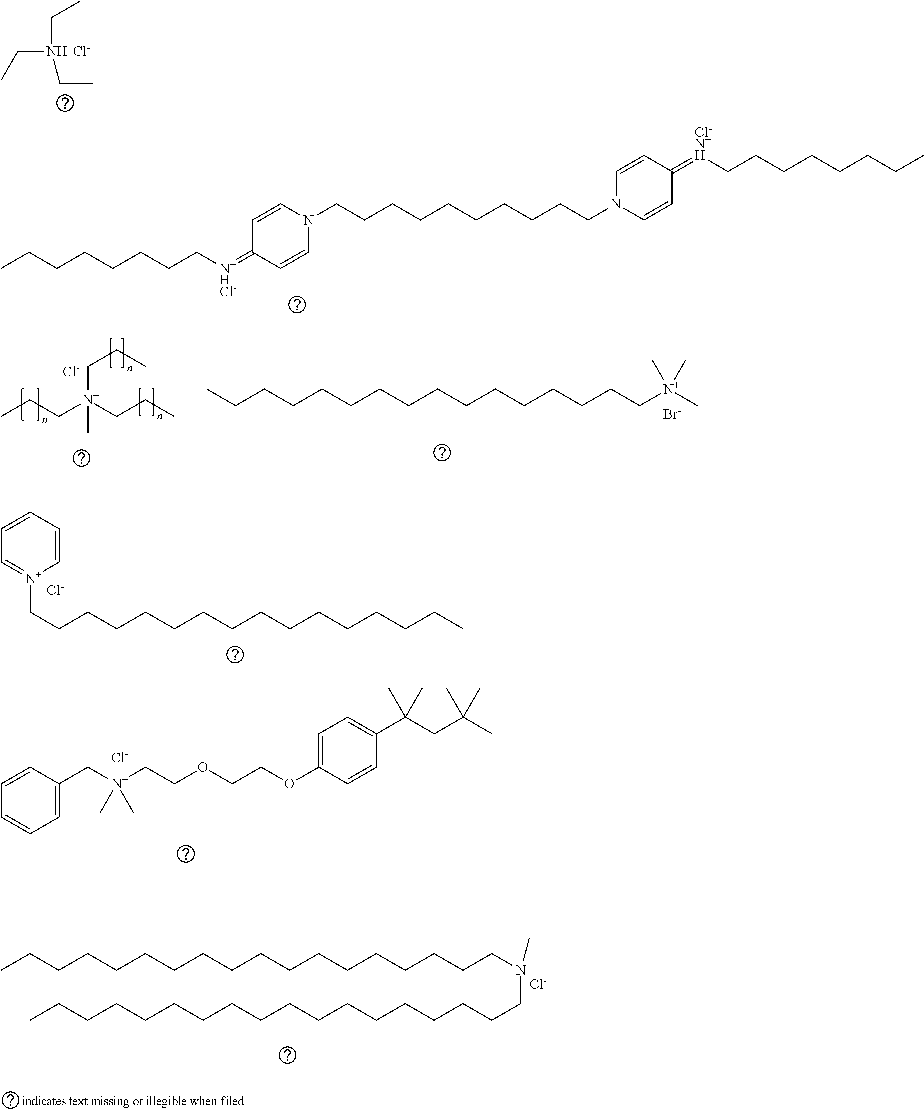

Exemplary anionic surfactants include, but are not limited to, alkylbenzene sulfonates such as RHODACAL series from Solvay, IL, alcohol ether sulfonates, alkane sulfonates, alcohol sulfonates such as DOWFax and TRITON series from DOW Michigan, or alkyl ether sulfates such as DISPONIL series from BASF Germany. Various combinations of surfactants may be used, if desired.

In certain embodiments, a surfactant is used in an amount of at least 0.25 part, relative to 100 parts by w eight of monomer starting material. In certain embodiments, a surfactant is used in an amount of up to 8 parts, relative to 100 parts by weigh of monomer starting material.

In certain embodiments, the (meth)acrylate emulsion polymer is formed from components that also include one or more plasticizers, such as glycerol. In certain embodiments, if present, a plasticizer is used in an amount of no more than 1 part, relative to 100 parts by weight of monomer starting material.

To characterize emulsion polymers, molecular weight is commonly used. In certain embodiments, the (meth)acrylate emulsion polymer has a weight average molecular weight of at least 200,000 Daltons, at least 250,000 Daltons, at least 300,000 Daltons, or at least 400,000 Daltons. In certain embodiments, the (meth)acrylate emulsion polymer has a weight average molecular weight of up to 1,000,000 Daltons, up to 800,000 Daltons, or up to 600,000 Daltons. The molecular weights can be determined using tetrahydrofuran and gel permeation chromatography (GPC).

In certain embodiments, the particles of the (meth)acrylate emulsion have an average particle size of less than 1 micron, and often less than 800 microns.

In certain embodiments, the (meth)acrylate emulsion polymer has a solids content of at least 40 wt-%, or at least 50 wt-%. In certain embodiments, the (meth)acrylate emulsion polymer has a solids content of up to 75 wt-%, or up to 60 wt-%. This can be determined by fully drying the (meth)acrylate emulsion polymer.

### Flame Retardant

The adhesives of the present disclosure include a non-halogenated flame retardant (i.e., flame-retardant agents). In certain embodiments the flame retardant is a non-halogenated, heavy metal-free compound. In certain embodiments, such flame retardant includes a phosphorus-containing compound, a borate, an inorganic metal-containing compound, a char former, a clay, a graphite, a silicate, or a combination thereof.

In certain embodiments, the flame retardant includes a phosphorus-containing compound. The many varieties of phosphorus-containing compounds available generally fall into two classes—gas-phase acting agents and condensed-phase (i.e., char-forming) agents. Examples of suitable phosphorus-containing compounds include a phosphate, a phosphate ester, a phosphonate, a phosphinate, etc.

In certain embodiments, the phosphorus-containing compound is selected from the group consisting of ammonium pyrophosphate, ammonium polyphosphate, diethyl phosphinate, ethylene diamine phosphate, melamine pyrophosphate, melamine polyazine phosphate, melamine tolylmagnesium phosphate, melamine zinc phosphate, piperazine phosphate, pyrophosphoric acid salt, 9,10-dihydro-9-oxa-10-phosphaphenanthrene 10-oxide, hydroxyphenyl phosphinyl propanoic acid, red phosphorus, triphenyl phosphine oxide, and a combination thereof.

In certain embodiments, the flame retardant includes an inorganic metal-containing compound. Examples of suitable inorganic metal-containing compounds include oxides and hydroxides. In certain embodiments, the inorganic metal-containing compound is selected from magnesium hydroxide, aluminum trihydrate, and a combination thereof.

In certain embodiments, the flame retardant includes compounds sometimes referred to as char formers. These can include several classes of materials, including, for example, melamine compounds and derivatives, hydroxy/oxygen rich compounds such as pentarythritol and its dimer and larger species, and other char formers such as metal hydrates, hydroxides, and/or oxides.

In certain embodiments, the non-halogenated flame retardants may be present in particulate form, dissolved in aqueous solution, or both. Typically, by adding both particulate non-halogenated flame retardants and non-halogenated flame retardants dissolved in aqueous solution, the viscosity of the resulting water-borne PS A may be adjusted by adjusting the ratio between particulate and dissolved flame retardant without compromising flame retardancy. When particulate flame retardants are used, smaller particle size leads to improved flame retardancy. In some embodiments, the particulate flame retardant has median particle size (Dv50) of less than 20 micrometers, in some less than 18 micrometers, in some less than 10 micrometers, in some less than 7 micrometers, and in some less than 6 micrometers. Optionally, median particle size (Dv50) may be at least 1 micrometer, at least 2 micrometers, or at least 4 micrometers.

Any combination of flame retardants may be used. In certain embodiments, the non-halogenated flame retardant is present in an amount of at least 0.1 wt-%, at least 0.5 wt-%, at least 1 wt-%, at least 2 wt-%, at least 5 wt-%, or at least 10 wt-%, based on the total weight of the fire-retardant pressure sensitive adhesive. In certain embodiments, the non-halogenated flame retardant is present in an amount of up to 30 wt-%, or up to 25 wt-%, based on the total weight of the fire-retardant pressure sensitive adhesive.

### Optional Adhesive Additives

The adhesives of the present disclosure preferably include water. In certain embodiments, the adhesives include up to 50% solids. In certain embodiments, the adhesive includes at least 10% solids, at least 20% solids, or at least 30% solids.

In certain embodiments, the adhesives of the present disclosure typically do not include common solvents; however, they could be used to aid in drying or film formation if desired. In this context, “common solvents” refer to low molecular weight organic liquids commonly used as solvents by practitioners in the art, which may include aliphatic and alicyclic hydrocarbons (e.g., hexane, heptane, and cyclohexane), aromatic solvents (e.g., benzene, toluene, and xylene), ethers (e.g., diethyl ether, glyme, diglyme, diisopropyl ether, and tetrahydrofuran), esters (e.g., ethyl acetate and butyl acetate), alcohols (e.g., ethanol and isopropyl alcohol), ketones (e.g., acetone, methyl ethyl ketone, and methyl isobutyl ketone), sulfoxides (e.g., dimethyl sulfoxide), amides (e.g., N,N-dimethylformamide, N,N-dimethylacetamide, and N-methyl-2-pyrrolidone), halogenated solvents (e.g., methylchloroform, 1,1,2-trichloro-1,2,2-trifluoroethane, trichloroethylene, and trifluorotoluene), and mixtures thereof; providing that “common solvents” excludes species that act as monomers or otherwise as reactants in a given composition;

In certain embodiments, the adhesives of the present disclosure include a tackifier. Suitable tackifiers may include terpene phenolics, rosins, rosin esters, esters of hydrogenated rosins, synthetic hydrocarbon resins and combinations thereof. Commercially available tackifying resins may be used, such as: FORAL 85E (a glycerol ester of highly hydrogenated refined gum rosin) commercially available from Eastman, Middelburg, NL, FORAL 3085 (a glycerol ester of highly hydrogenated refined wood rosin) commercially available from Hercules Inc., Wilmington, DE; ESCOREZ 2520 and ESCOREZ 5615 (aliphatic/aromatic hydrocarbon resins) commercially available from ExxonMobil Corp., Houston, TX; and REGALITE 7100 (a partially hydrogenated hydrocarbon resin) commercially available from Eastman, Kingsport, TN; SUPER ESTER E-730-55 and PINECRYSTAL KE-100, both of which are available from Arakawa, Japan; and AQUATAC 2685 available from Kraton, Jacksonville, FL.

In certain embodiments, if present, the tackifier is present in an amount of at least 0.1 wt-%, at least 1 wt-%, at least 5 wt-%, or at least 8 wt-%, based on the total weight of the adhesive. In certain embodiments, if present, the tackifier is present in an amount of up to 60 wt-%, up to 45 wt-%, up to 30 wt-%, up to 20 wt-%, or up to 15 wt-%, based on the total weight of the adhesive.

In certain embodiments, a tackifier is not used to enhance fire retardancy, particularly because they typically include high carbon content.

### Adhesive Articles and Methods of Use

The present disclosure also provides an adhesive article (e.g., a tape).

In one embodiment, the adhesive article includes a first adhesive layer disposed on a first surface of a supporting layer, wherein the first adhesive layer includes the fire-retardant pressure sensitive adhesive described herein.

In another embodiment, the adhesive article includes a second adhesive layer disposed on a second surface of the supporting layer (e.g., thereby forming a double-sided tape), wherein the second adhesive layer includes the fire-retardant pressure sensitive adhesive described herein.

Examples of supporting layers include standard tape backings such as biaxially oriented polypropylene, polyethylene terephthalate, nylon, paper, etc. They may be in the form or a woven or nonwoven, for example. These could also have additives to improve the fire retardancy if desired.

If desired, a release liner may be included.

Preferably, an adhesive article of the present disclosure, when tested according to the Burn Test described in the Examples Section, a flame self-extinguishes within 60 seconds and does not spread to the farthest point of the sample from application of the flame.

Preferably, an adhesive article of the present disclosure, when tested according to the OLS Shear Test described in the Examples Section, results in a bond that lasts at least 1500 minutes when tested with a 1-kg weight.

The pressure sensitive adhesives of the present disclosure can be used to join two adherends. Exemplary uses include a method of joining two adherends comprising joining a first adherend to the pressure sensitive adhesive described herein and joining a second adherend to the pressure sensitive adhesive.

### Exemplary Embodiments

Embodiment 1 is a fire-retardant pressure sensitive adhesive comprising: a (meth)acrylate polymer comprising interpolymerized monomers comprising: (a) an acid-functional (meth)acrylate monomer or oligomer thereof; (b) a hydroxy-functional (meth)acrylate monomer or oligomer thereof; (c) a non-cationic nitrogen-containing monomer or oligomer thereof; and (d) a (meth)acrylate ester of a linear or branched alcohol having 3 to 4 carbon atoms and/or a (meth)acrylate ester of a linear, branched, or cyclic alcohol having 5 to 20 carbon atoms; and a non-halogenated flame retardant.
Embodiment 2 is the adhesive of embodiment 1 wherein the (meth)acrylate polymer has a glass transition temperature (Tg) of −10° C. or less.
Embodiment 3 is the adhesive of embodiment 1 or 2 wherein the acid-functional (meth)acrylate monomer is selected from the group consisting of methacrylic acid, acrylic acid, and a combination thereof.
Embodiment 4 is the adhesive of an of the previous embodiments wherein the acid-functional (meth)acrylate monomer is a carboxylic acid-functional (meth)acrylate short chain ester monomer or oligomer thereof.
Embodiment 5 is the adhesive of embodiment 4 wherein the carboxylic acid-functional (meth)acrylate short chain ester monomer or oligomer thereof is selected from the group consisting of beta-carboxy ethyl acrylate, 2-methacryloyloxyethyl succinate, fumaric acid, an oligomer thereof, and a combination thereof.
Embodiment 6 is the adhesive of any of the previous embodiments wherein the hydroxy-functional (meth)acrylate monomer is selected from the group consisting of 4-hydroxy butyl acrylate, 2-hydroxy ethyl acrylate, hydroxy propyl acrylate, an oligomer thereof, and a combination thereof.
Embodiment 7 is the adhesive of any of the previous embodiments wherein the non-cationic nitrogen-containing monomer is selected from the group consisting of N-vinyl caprolactam, N-vinyl pyrrolidinone, acrylonitrile, dimethyl acrylamide, acrylamide, t-octyl acrylamide, and a combination thereof.
Embodiment 8 is the adhesive of any of the previous embodiments wherein monomers (a), (b), and (c) are present in a combined amount of at least 8 parts, at least 10 parts, or at least 12 parts (i.e., wt-%), based on the total amount of the interpolymerized monomers.
Embodiment 9 is the adhesive of any of the previous embodiments wherein monomers (a), (b), and (c) are present in a combined amount of up to 30 parts, up to 25 parts, up to 20 parts, or up to 18 parts, based on the total amount of the interpolymerized monomers.
Embodiment 10 is the adhesive of any of the previous embodiments wherein the interpolymerized monomers comprise at least 0.1 part, at least 0.5 part, or at least 1 part of the acid-functional (meth)acrylate monomer, based on the total amount of the interpolymerized monomers.
Embodiment 11 is the adhesive of any of the previous embodiments wherein the interpolymerized monomers comprise up to 30 parts, up to 20 parts, up to 10 parts, up to 8 parts, up to 6 parts, up to 5 parts, or up to 4 parts of the acid-functional (meth)acrylate monomer selected from the group consisting of methacrylic acid, acrylic acid, and a combination thereof, based on the total amount of the interpolymerized monomers.
Embodiment 12 is the adhesive of any of the previous embodiments wherein the interpolymerized monomers comprise up to 30 parts, up to 20 parts, up to 10 parts, 8 parts, up to 6 parts, up to 5 parts, or up to 4 parts of the acid-functional (meth)acrylate monomer selected from a carboxylic acid-functional short chain ester monomer or oligomer thereof, based on the total amount of the interpolymerized monomers.
Embodiment 13 is the adhesive of any of the previous embodiments wherein the interpolymerized monomers comprise at least 0.1 part, at least 0.5 part, or at least 1 part of the hydroxy-functional monomer, based on the total amount of the interpolymerized monomers.
Embodiment 14 is the adhesive of any of the previous embodiments wherein the interpolymerized monomers comprise up to 20 parts, up to 15 parts, up to 10 parts, up to 8 parts, or up to 6 parts of the hydroxy-functional monomer, based on the total amount of the interpolymerized monomers.
Embodiment 15 is the adhesive of any of the previous embodiments wherein the interpolymerized monomers comprise at least 0.1 part, at least 0.5 part, or at least 1 part of the non-cationic nitrogen-containing monomer, based on the total amount of the interpolymerized monomers.
Embodiment 16 is the adhesive of any of the previous embodiments wherein the interpolymerized monomers comprise up to 8 parts, up to 6 parts, up to 4 parts, or up to 2 parts of the non-cationic nitrogen-containing monomer, based on the total amount of the interpolymerized monomers.
Embodiment 17 is the adhesive of any of the previous embodiments wherein the interpolymerized monomers further comprise a low molecular weight stabilizing monomer comprising an ethylenically unsaturated ester monomer.
Embodiment 18 is the adhesive of embodiment 17 wherein the low molecular weight stabilizing monomer is selected from the group consisting of vinyl acetate, methyl acrylate, ethyl acrylate, methyl methacrylate, and a combination thereof.
Embodiment 19 is the adhesive of embodiment 17 or 18 wherein the interpolymerized monomers comprise up to 5 parts of the stabilizing monomer, based on the total amount of the interpolymerized monomers.
Embodiment 20 is the adhesive of any of embodiments 17 through 19 wherein the interpolymerized monomers comprise at least 0.1 part, at least 0.5 part, or at least 1 part of the stabilizing monomer, based on the total amount of the interpolymerized monomers.
Embodiment 21 is the adhesive of any of the previous embodiments wherein the interpolymerized monomers further comprise a cationic monomer.
Embodiment 22 is the adhesive of embodiment 21 wherein the cationic monomer is a cationic quaternary amine.
Embodiment 23 is the adhesive of embodiment 21 or 22 wherein the interpolymerized monomers comprise up to 8 parts, up to 6 parts, up to 4 parts, or up to 2 parts of the cationic monomer, based on the total amount of the interpolymerized monomers.
Embodiment 24 is the adhesive of any of embodiments 21 through 23 wherein the interpolymerized monomers comprise at least 0.1 part, at least 0.5 part, or at least 1 part of the cationic monomer, based on the total amount of the interpolymerized monomers.
Embodiment 25 is the adhesive of any of the previous embodiments wherein the interpolymerized monomers comprise a (meth)acrylate ester of a linear or branched alcohol having 3 to 4 carbon atoms.
Embodiment 26 is the adhesive of embodiment 25 wherein the (meth)acrylate ester of a linear or branched alcohol having 3 to 4 carbon atoms is selected from the group consisting of n-propyl(meth)acrylate, isopropyl(meth)acrylate, n-butyl(meth)acrylate, isobutyl(meth)acrylate, tert-butyl(meth)acrylate, and a combination thereof.
Embodiment 27 is the adhesive of embodiment 26 wherein the (meth)acrylate ester of a linear or branched alcohol having 3 to 4 carbon atoms is n-butyl acrylate.
Embodiment 28 is the adhesive of any of embodiments 25 through 27 wherein the interpolymerized monomers comprise at least 40 parts of the (meth)acrylate ester of a linear or branched alcohol having 3 to 4 carbon atoms, based on the total amount of interpolymerized monomers.
Embodiment 29 is the adhesive of any of embodiments 25 through 28 wherein the interpolymerized monomers comprise up to 95 parts of the (meth)acrylate ester of a linear or branched alcohol having 3 to 4 carbon atoms, based on the total amount of interpolymerized monomers.
Embodiment 30 is the adhesive of any of the previous embodiments wherein the interpolymerized monomers comprise a (meth)acrylate ester of a linear, branched, or cyclic alcohol having 5 to 20 carbon atoms.
Embodiment 31 is the adhesive of embodiment 30 wherein the (meth)acrylate ester of a linear, branched, or cyclic alcohol having 5 to 20 carbon atoms is selected from the group consisting of n-pentyl(meth)acrylate, iso-pentyl(meth)acrylate, n-hexyl(meth)acrylate, iso-hexyl(meth)acrylate, cyclohexyl(meth)acrylate, phenyl(meth)acrylate, 1-octyl(meth)acrylate, iso-octyl(meth)acrylate, 2-octyl(meth)acrylate, 3-octyl(meth)acrylate, 2-ethylhexyl(meth)acrylate, decyl(meth)acrylate, lauryl(meth)acrylate, 2-propylheptyl(meth)acrylate, stearyl(meth)acrylate, isobornyl(meth)acrylate, benzyl(meth)acrylate, octadecyl(meth)acrylate, nonyl(meth)acrylate, dodecyl(meth)acrylate, isophoryl(meth)acrylate, and a combination thereof.
Embodiment 32 is the adhesive of embodiment 31 wherein the (meth)acrylate ester of linear, branched, or cyclic alcohol having 5 to 20 carbon atoms is iso-hexyl acrylate.
Embodiment 33 is the adhesive of any of embodiments 30 through 32 wherein the interpolymerized monomers comprise at least 10 parts of the (meth)acrylate ester of a linear, branched, or cyclic alcohol having 5 to 20 carbon atoms, based on the total amount of interpolymerized monomers.
Embodiment 34 is the adhesive of any of embodiments 30 through 33 wherein the interpolymerized monomers comprise up to 60 parts of the (meth)acrylate ester of a linear, branched, or cyclic alcohol having 5 to 20 carbon atoms, based on the total amount of interpolymerized monomers.
Embodiment 35 is the adhesive of any of the previous embodiments wherein the interpolymerized monomers further comprise a crosslinking monomer.
Embodiment 36 is the adhesive of embodiment 35 wherein the wherein the interpolymerized monomers comprise no more than 0.5 wt-% crosslinker, based on the total amount of the interpolymerized monomers.
Embodiment 37 is the adhesive of any of the previous embodiments further comprising a tackifier.
Embodiment 38 is the adhesive of embodiment 37 wherein the tackifier is present in an amount of at least 0.1 wt-%, at least 1 wt-%, at least 5 wt-%, or at least 8 wt-%, based on the total weight of the adhesive.
Embodiment 39 is the adhesive of embodiment 37 or 38 wherein the tackifier is present in an amount of up to 60 wt-%, up to 45 wt-%, up to 30 wt-%, up to 20 wt-%, or up to 15 wt-%, based on the total weight of the adhesive.
Embodiment 40 is the adhesive of any of the previous embodiments wherein the non-halogenated flame retardant comprises a phosphorus-containing compound, a borate, an inorganic metal-containing compound (e.g., an oxide or a hydroxide), a char former, a clay, a graphite, a silicate, or a combination thereof.
Embodiment 41 is the adhesive of embodiment 40 wherein the non-halogenated flame retardant comprises a phosphorus-containing compound.
Embodiment 42 is the adhesive of embodiment 41 wherein the phosphorus-containing compound is selected from the group consisting of ammonium pyrophosphate, ammonium polyphosphate, diethyl phosphinate, ethylene diamine phosphate, melamine pyrophosphate, melamine polyazine phosphate, melamine polymagnesium phosphate, melamine zinc phosphate, piperazine phosphate, pyrophosphoric acid salt, 9,10-dihydro-9-oxa-10-phosphaphenanthrene 10-oxide, hydroxyphenyl phosphinyl propanoic acid, red phosphorus, triphenyl phosphine oxide, and a combination thereof.
Embodiment 43 is the adhesive of embodiment 40 wherein the non-halogenated flame retardant comprises an inorganic metal-containing compound.
Embodiment 44 is the adhesive of embodiment 43 wherein the inorganic metal-containing compound is selected from the group consisting of magnesium hydroxide, alumina trihydrate, and a combination thereof.
Embodiment 45 is the adhesive of any of the previous embodiments wherein the non-halogenated flame retardant is present in an amount of at least 0.1 wt-%, at least 0.5 wt-%, at least 1 wt-%, at least 2 wt-%, at least 5 wt-%, or at least 10 wt-%, based on the total weight of the fire-retardant pressure sensitive adhesive.
Embodiment 46 is the adhesive of any of the previous embodiments wherein the non-halogenated flame retardant is present in an amount of up to 30 wt-%, or up to 25 wt-%, based on the total weight of the fire-retardant pressure sensitive adhesive.
Embodiment 47 is the adhesive of any of the previous embodiments further comprising water.
Embodiment 48 is the adhesive of embodiment 47 comprising up to 50% solids.
Embodiment 49 is the adhesive of embodiment 47 or 48 comprising at least 10% solids, at least 20% solids, or at least 30% solids.
Embodiment 50 is the adhesive of any of the previous embodiments comprising a common solvent.
Embodiment 51 is the adhesive of any of the previous embodiments wherein the (meth)acrylate polymer is formed from components comprising an optional additive selected from the group consisting of a surfactant, a chain transfer agent, a plasticizer, and a combination thereof.
Embodiment 52 is the adhesive of any of the previous embodiments wherein the flame retardant is in particulate form.
Embodiment 53 is the adhesive of embodiment 52 wherein the particulate flame retardant has a median particle size (Dv50) of less than 20 micrometers, less than 18 micrometers, less than 10 micrometers, or less than 7 micrometers.
Embodiment 54 is the adhesive of embodiment 52 or 53 wherein the particulate flame retardant has a median particle size (Dv50) of at least 1 micrometer, at least 2 micrometers, or at least 4 micrometers.
Embodiment 55 is an adhesive article (e.g., tape) comprising a first adhesive layer disposed on a first surface of a supporting layer, wherein the first adhesive layer comprises the fire-retardant pressure sensitive adhesive of any of embodiments 1 through 54.
Embodiment 56 is the adhesive article of embodiment 55 comprising a second adhesive layer disposed on a second surface of the supporting layer, wherein the second adhesive layer comprises the fire-retardant pressure sensitive adhesive of any of embodiments 1 through 54.
Embodiment 57 is the adhesive article of embodiment 55 or 56 wherein the supporting layer comprises biaxially oriented polypropylene, polyethylene terephthalate, nylon, or paper.
Embodiment 58 is the adhesive article of any of embodiments 55 through 57, when tested according to the Burn Test described in the Examples Section, a flame self-extinguishes within 60 seconds and does not spread to the farthest point of the sample from application of the flame.
Embodiment 59 is the adhesive article of any of embodiments 55 through 58, when tested according to the OLS Shear Test described in the Examples Section, results in a bond that lasts at least 1500 minutes when tested with a 1-kg weight.
Embodiment 60 is the use of the adhesive article (e.g., tape) of any of embodiments 55 through 59 to join two adherends.
Embodiment 61 is the use the fire-retardant pressure sensitive adhesive of any of embodiments 1 through 54 to join two adherends.
Embodiment 62 is a method of joining t wo adherends comprising joining a first adherend to the adhesive article of any of embodiments 55 through 59 and joining a second adherend to the adhesive article.
Embodiment 63 is a method of joining two adherends comprising joining a first adherend to the pressure sensitive adhesive of any of embodiments 1 through 54 and joining a second adherend to the pressure sensitive adhesive.
Embodiment 64 is a flexible ductwork comprising the pressure sensitive adhesive of any of embodiments 1 through 54 or an adhesive article of any of embodiments 55 through 59.

### Examples

Objects and advantages of this disclosure are further illustrated by the following non-limiting examples, but the particular materials and amounts thereof recited in these examples, as well as other conditions and details, should not be construed to unduly limit this disclosure.

Unless otherwise noted, all parts, percentages, ratios, etc. in the Examples and the rest of the specification are by weight.

TABLE 1
Materials

| Designation | Description |
|---|---|
| 3630 | An aqueous all-acrylic pressure sensitive dispersion, 60% in water, available |
| | under trade designation “ACRONAL 3630”, obtained from BASF SE, |
| | Ludwigshafen, Germany. |
| 9466 | Encore 9466 an aqueous pressure sensitive adhesive, available under trade |
| | designation “ENCORE 9466”, obtained from Arkema, Colombes, France. |
| BCEA | 2-Carboxyethyl acrylate, obtained from Solvay, Princeton, NJ. |
| APG 325 N | Nonionic alkyl polyglycoside surfactant, obtained from BASF SE, |
| | Ludwigshafen, Germany. |
| BA | Butyl Acrylate, obtained from BASF SE, Ludwigshafen, Germany. |
| DMAEA-MCL (Quat) | N,N-dimethylaminoethyl acrylate methyl chloride quaternary, 80% in water, |
| | obtained under the trade designation “AGEFLEX FA1Q80MC”, obtained |
| | from BASF SE, Ludwigshafen, Germany. |
| IOA | Isooctyl acrylate, obtained from 3M Company, St. Paul, MN. |
| NVC | N-vinyl caprolactam, obtained from BASF SE, Ludwigshafen, Germany. |
| MAA | Methacrylic acid, obtained from Alfa Aesar, Ward Hill, MA. |
| OP935 | Organic phosphinate, obtained from Clariant AG, Frankfurt am Main, |
| | Germany. |
| PTMP | Pentaerythritol tetrakis(3-mercaptopropionate), obtained from Evans |
| | Chemical, Teaneck, NJ. |
| Procetyl-AWS | Procetyl-AWS-LQ-(AP), a water soluble nonionic liquid surfactant, |
| | obtained from Croda Inc., Vaughan, Ontario, Canada. |
| SE780 | Snowtack SE780g, Water dispersed rosin ester tackifier, obtained from |
| | Lawter, Chicago, IL. |
| t-8-ACM | t-Octyl acrylamide, obtained from Sigma Aldrich, St. Louis, MO. |
| V-50 | 2,2′-Azobis (2-amidinopropane) dihydrochloride, obtained from Wako |
| | Chemicals USA, Richmond, VA. |
| VA | Vinyl acetate, obtained from Alfa Aesar, Ward Hill, MA. |

### Synthesis of Water-Based Emulsion Polymer (MAZAP)

Water-based emulsion polymer (MAZAP) was made according to patent application WO 2014/093375 A1. A 1-liter (1.057-quart) resin flask filled with condenser, thermocouple, and overhead stirrer was charged with 45.8 grams (g) (1.616 ounce (oz)) BA followed by addition of 0.2 g (0.007 oz) of PTMP, 42 g (1.482 oz) IOA, 1.25 g (0.0441 oz) DMAEA-MCL, 2 g (0.0705 oz) BCEA, 2 g (0.0705 oz) NVC, 2 g (0.0705 oz) MAA, 2 g (0.0705 oz) VA, 100 g (3.53 oz) water, and 4 g (0.141 oz) APG-325 N. The reaction mixture was purged with nitrogen for 30 minutes while overhead stirrer agitated at a rate of 120 rpm after which 0.375 g (0.0132 oz) V-50 was added to the flask. Two heat lamps on either side of the flask are turned on to heat the reaction mixture to a 50° C. (122° F.) set point. The reaction is left to exotherm once the exotherm is complete the reaction is then left for 6 hours at 60° C. (140° F.) to complete. The pH of the resulting solution was adjusted to between 4 and 4.2 by adding aqueous potassium hydroxide solution, followed by filtering through a PET-50GG-355 mesh having an opening of 355 micrometers (45 mesh) (available from Sefar Incorporated, Buffalo, NY). The amount of filtered coagulum was typically less than 1% by weight of the total amount of monomer, unless otherwise noted. The resulting emulsion was found to contain less than 0.5% wt. percent unreacted monomer by gravimetric analysis.

The exemplary adhesive formulations made using this procedure are listed in Table 2. Examples 1-6 are comparatives examples demonstrating improvements in fire resistance of the formulations with each monomer addition. Examples 7-11 are examples with various combinations of monomers from the defined groups. Examples 12-13 are comparative commercially available emulsions diluted to similar solids with flame-retardant agents added using the same ratios of adhesive solids.

TABLE 2

| | Adhesive | | | | | | | | | | | | |
|---|---|---|---|---|---|---|---|---|---|---|---|---|---|
| | Monomers | | | | | | | | | | | | |
| | (Monomer | | | | | Monomer (c) | | Optional | | | | | |
| | (d)) | | Monomer (a) | | Monomer (b) | | T- | Monomers | | CTA | Surfactant | Initiator | Water |
| Examples | BA | IOA | BCEA | MAA | HBA | NVC | 8Acm | Quat | VA | PTMP | APG | V-50 | H2O |
| Ex-1 | 91 | — | — | 2 | — | — | — | 2 | 5 | 0.1 | 4 | 0.375 | 122.2 |
| (COMP) | | | | | | | | (2.5) | | | | | |
| Ex-2 | 45.5 | 45.5 | — | 2 | — | — | — | 2 | 5 | 0.1 | 4 | 0.375 | 122.2 |
| (COMP) | | | | | | | | (2.5) | | | | | |
| Ex-3 | 43.4 | 41.5 | — | 2 | — | 8 | | 2 | 5 | 0.1 | 4 | 0.375 | 122.2 |
| (COMP) | | | | | | | | (2.5) | | | | | |
| Ex-4 | 45.4 | 43.5 | 4 | 2 | — | | — | 2 | 5 | 0.1 | 4 | 0.375 | 122.2 |
| (COMP) | | | | | | | | (2.5) | | | | | |
| Ex-5 | 87.82 | — | 2 | 2 | — | 2 | — | 1 | 5 | 0.18 | 4 | 0.375 | 122.2 |
| (COMP) | | | | | | | | (1.25) | | | | | |
| Ex-6 | 86.9 | — | 6 | — | 2 | — | — | 1 | 5 | 0.1 | 4 | 0.375 | 122.2 |
| (COMP) | | | | | | | | (1.25) | | | | | |
| Ex-7 | 80.9 | — | — | 2 | 6 | 6 | — | 1 | 5 | 0.1 | 4 | 0.375 | 122.2 |
| | | | | | | | | (1.25) | | | | | |
| Ex-8 | 84.9 | — | 4 | — | 2 | 4 | — | 1 | 5 | 0.1 | 4 | 0.375 | 122.2 |
| | | | | | | | | (1.25) | | | | | |
| Ex-9 | 74.82 | 10 | 6 | — | 2 | 2 | — | 1 | 5 | 0.18 | 4 | 0.375 | 122.2 |
| | | | | | | | | (1.25) | | | | | |
| Ex-10 | 45.8 | 42 | 2 | 2 | 4 | 2 | — | 1 | 2 | 0.2 | 4 | 0.375 | 100 |
| | | | | | | | | (1.25) | | | | | |
| Ex-11 | 78.9 | — | 4 | — | 2 | — | 10 | 1 | 5 | 0.1 | 4 | 0.375 | 122.2 |
| | | | | | | | | (1.25) | | | | | |

| | |
|---|---|
| Ex-12 | Commercial Emulsion Acrylic Adhesive BASF: Acronal 3630 |
| (COMP) | |
| Ex-13 | Commercial Emulsion Acrylic Adhesive Arkema: Encore 9466 |
| (COMP) | |

### Glass Transition Temperature Test

DMA was used to measure the storage modulus, viscosity, and glass transition temperatures of adhesive compositions. A small sample of pre-adhesive composition was transferred onto the bottom plate of a rheometer (obtained from TA Instruments, New Castle, Delaware, under the trade designation “ARES G2 RHEOMETER”). The rheometer had parallel 8 millimeters (mm) (0.315 inch) diameter top and 25 mm (0.984 inch) bottom plates. The top plate of the rheometer was brought down onto the sample of pre-adhesive composition until the parallel plates were separated by 1 mm. Excess material was trimmed away from the edge of the 8-mm top plate. A temperature ramp test method was used where shear moduli, viscosity, and tan(6) were estimated while sample was subjected to oscillatory shear (frequency=1 Hz) and at the same time the sample temperature was continuously increased from −75° C. (−103° F.) to 150° C. (302° F.) at a rate of 3° C./minute (5.4° F.). The strain amplitude was 0.05% at −75° C. (−103° F.) increasing with temperature to 3.6% iteratively as needed to achieve a minimum torque of 10 p-Nm (7.376 Foot-pounds). Storage modulus (G′) was reported in Pascals (Pa). Viscosity (i) of the pre-adhesive composition was reported in Pascal-seconds (Pa-s). Tan (6) was calculated as the ratio of G″/G′ (loss modulus/storage modulus). The temperature where the tan(6) curve had a local peak was reported as the glass transition temperature (“T_{g}”).

Sample Preparation with Flame Retardant

To prepare samples for coating, they were mixed in either of two manners. For the first set of samples in Examples 1-6, samples were mixed using the following procedures. OP935 flame retardant was added to a 2-liter (2.113 quart) plastic jar along with water and Procetyl-AWS to make a mixture with the amounts indicated in Table 3 using a high shear mixer to disperse OP935 into the water making a thick paste. The paste was added to a 40-milliliter glass vial along with the MAZAP emulsion and tackifier in the amounts indicated in Table 4, then mixed using a vortex mixer for two minutes.

TABLE 3
Fire-Retardant Mixture (FR Mixture) Added to MAZAP Emulsion

| Material | Amount (g) |
|---|---|
| OP935 | 50 |
| Water (deionized) | 50 |
| Procetyl-AWS | 0.5 |

TABLE 4
Formulation of Fire-Retardant Adhesive for Examples 1-7

| Material | Amount (g) |
|---|---|
| FR mixture | 4 |
| Tackifier | 2 |
| MAZAP | 10 |

For Examples 7-12, the samples were mixed by direct add as shown in Table 5. The emulsion, water, and Procetyl-AWS were added together and gently mixed. Then the OP935 powder was added and mixed vigorously with a 4-blade impeller mixer. The sample was stirred until an even smooth texture was obtained with no visible grits.

TABLE 5
Formulation Make-up for Examples 1-13

| | Emulsion | SE- | | Procetyl- | |
|---|---|---|---|---|---|
| | Base | 780G | OP935 | AWS | Water |
| Ex: 1-7 | 100 | 20 | 20 | 0.2 | 20 |
| Ex: 8-11 | 100 | — | 17.5 | 0.175 | — |
| Ex: 12 | 83.8 | — | 17.6 | 1 | 16.2 |
| Ex: 13 | 79.6 | — | 17.6 | 1 | 20.4 |

### Specimen Preparation for Burn and OLS Tests

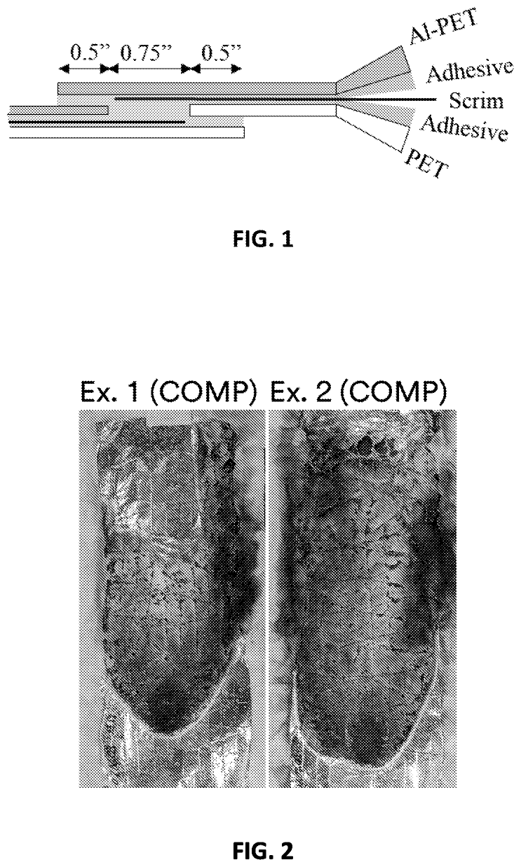

Each formulation solution was applied on a 0.5-mil (12.5-micron) PET backing suitable for coating water-based adhesives. In this application, one PET sheet was aluminum sputtered PET and the other was a standard corona treated PET. For each sample the Aluminum side and corona treated side was coated with adhesive then laminated together as described below. A Meyer Rod, size 12 or 18, was used to draw down the solutions to the desired thickness and coat weight, also dependent on initial solids of the solution. All samples within each example set were diluted to a similar solids level for best comparison of sample test. The drawn-down sample was then dried with forced hot air to visibly dry, taking care to not overheat the sample to where the PET begins to deform and tighten. A second sample was then coated in the same manner and the two were laminated together, adhesive sides towards each other with a fiberglass scrim (similar to image shown) in between the sheets as shown in FIG. 1. Two lamination methods were used for burn samples. For Examples 1-4 the two adhesive coated PET sheets were laminated directly onto each other with a length of 30 to 45 cm (11.81 to 17.72 inches (in)) to make a 15 cm (5.91 in) by 30-45 cm (11.81 to 17.72 in) sample with scrim between the two PET sheets, one being aluminum sputtered PET and the other a plain PET, both of 12.5 microns (0.000492 in) thick. For the second lamination method (used for OLS tests on all samples, and burn samples for Examples 5-13), the sheets when laminated were offset on their long edge by 1.25 inches (3.2 centimeter (cm)). This gave an unbound edge that can then be used to overlap to another sample, with the overlap of the next sample passing 0.5 inch (1.3 cm) on to the backside of the same sample, as shown in FIG. 1. This allowed construction of a sample of wider than 6 inches (15.2 cm), the base PET width with seams then occurring every six inches. This seam region was used for the overlap shear test, described below. Otherwise, the number of laminations were increased to build a sheet large enough for a desired burn test sample. Here a small patty size of 8.5×12 inches (21.6×30.5 cm) was used, setup as described below.

### OLS Shear Test

For OLS testing, a cut of 1-inch (2.5-cm) width was made perpendicular to this lamination overlap seam and used as a hang test to measure bond strength. Samples were pressed with a 5-lb (2.3-kilogram (kg)) roller. In this configuration, the adhesive to adhesive overlap was ¾×1 inch (1.9×2.5 cm) and the adhesive to backside of same side film was ½×1 inch (1.3×2.5 cm) as shown in FIG. 1. This was prepared with metal “C” hooks on each side to secure the sample with even pull force when a weight was hung. A sample “passes” this test if it lasts at least 1500 minutes with a 1-kg weight. The longer the better, which means that the more effective the formulation was at forming an adhesive bond.

### Burn Test

For burn testing, a method modeled after the UL-181 standard procedure for flexible air ducts was designed. Samples had a PET duct area of 8.5×12 inches (21.6×30.5 cm). This was made by coating enough PET sheets to form overlap sections of at least the desired area, then cut to size. Once the PET was cut it was allowed to sit for 24 hours, then it was attached to a fiberglass batt by stapling the edges, 3 staples to each side, evenly spaced. This formed the burn “patty.” The patty was then attached to a metal 6-inch (15.2-cm) duct with tape on the 4 corners, taking care to mount it in the bottom center of the curvature with the 12-inch (30.5 cm) length running the long direction of the duct. This duct was mounted for testing in a 450 fashion. The Bunsen burner was placed relative to the sample to be burned as described in the UL-181-2 inches (5.1 cm) from the bottom or starting edge of the burn sample, placed directly in the center, side to side of the sample, with the Bunsen tip 1.25 inches (3.2 cm) from the sample as measured vertically to the sample surface, and the flame being 2.5 inches (6.4 cm) long, with half the flame being blue and half being orange in color.

To begin the burn, the sample was placed in a burn hood, with only enough draw to bring the smoke vertically into the ventilation shaft, but no more so as not to disturb or “draw” the flame to either side of the sample. The burner was placed as described above, the hood door was closed, and the gas to the burner was started. Then after 5 seconds, it was ignited and the sample was allowed to burn until self-extinguished, or until 2 minutes had passed. Either by self-extinguishing or by burning the complete patty and any residual flame being put out by water spray.

With the sample patties being all the same size in each burn testing group, the area of burn was easily quantified and compared. The width and height of the burn area were both signatures of the burn resistance of the formulation. With a shorter height and width being evidence of a low degree of flammability. An additional parameter of flammability seen was the width of the “v” shape of the lower portion of the area of the sample where ignited. A more narrow “v” suggests less tendency for the flame to creep from the ignition source. A difference in flammability, or resistance to burning in the samples can be seen by the degree of residual unburned sample (seen as silver PET segments) in the general burn pattern area, which provides evidence of the ability of the sample to resist burning. The burn area measured was taken as the portion which the sample was burned through to the underlying fiberglass insulation to which the sample had been mounted. The width of this region was taken at the widest burn point and the height of the burn region as the average across the top burned edge of the sample. Samples were burned in groupings for most accurate comparisons to distinguish the improvements from each addition of the monomers.

### Test Results

Samples were coated at the thicknesses shown in each sample test table, using wound wire rod (Meyer rod, denoted as M ## in the standard Meyer rod number format). The base emulsion for each Example can be seen in Table 2 and the full formulation with flame-retardant agent and other additives can be seen in Table 5.

TABLE 6

| | | Burn | | | | | | | |
|---|---|---|---|---|---|---|---|---|---|
| | Coat | Width | Height | OLS | | | | | |
| Examples | Thickness | (cm) | (cm) | (min) | BA | IOA | VA | MAA | Quat |
| Ex-1 | M18 | 15.2 | 20.3 | 6 | 91 | 0 | 5 | 2 | 2 |
| (COMP) | | | | | | | | | |
| Ex-2 | M18 | 15.2 | 32.6 | 64 | 45 | 45 | 5 | 2 | 2 |
| (COMP) | | | | | | | | | |
| Comments: | | | | | | | | | |

| | |
|---|---|
| Ex-1 | Burn full width (6 inches (15.2 cm)), short height, burn region has narrow cone at start |
| (COMP) | |
| Ex-2 | Burn full width (6 inches (15.2 cm)), tall burn height, starting burn region has wide |
| (COMP) | almost square, not V Shape |

FIG. 2 shows the burn patty test results of the 2 formulations of Examples 1 and 2, coated at Meyer rod 18 thickness in a 450 burn using the formulations listed in Table 5 with the emulsions described in Table 2. The major difference between them was IOA and BA content, with Example 1 including higher BA content (no IOA). Higher BA content resulted in a reduced burn area and more effective fire retardancy with the same loading of flame-retardant agent OP935.

TABLE 7

| | | Burn | | | | | | | | | |
|---|---|---|---|---|---|---|---|---|---|---|---|
| | Coat | Width | Height | OLS | | | | | | | |
| Examples | Thickness | (cm) | (cm) | (min) | BA | IOA | NVC | BCEA | VA | MAA | Quat |
| Ex-2 | M12 | 15.2 | 29.7 | 58 | 45 | 45 | 0 | 0 | 5 | 2 | 2 |
| (COMP) | | | | | | | | | | | |
| Ex-3 | M12 | 12.0 | 23.5 | 62 | 41 | 41 | 8 | 0 | 5 | 2 | 1 |
| (COMP) | | | | | | | | | | | |
| Ex-4 | M12 | 14.5 | 24.2 | 100 | 43 | 43 | 0 | 4 | 5 | 2 | 1 |
| (COMP) | | | | | | | | | | | |

| | |
|---|---|
| Ex-2 | Burn full width (6 inches (15.2 cm)) and high, little residual PET |
| (COMP) | |
| Ex-3 | Burn was narrow, but high, little residual PET |
| (COMP) | |
| Ex-4 | Burn was wide, but short height, little residual PET |
| (COMP) | |

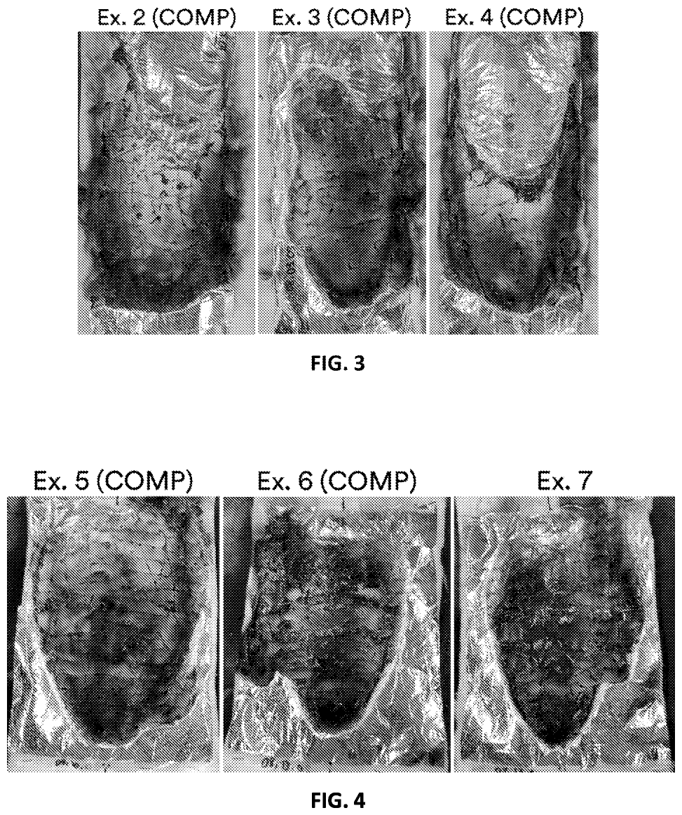

FIG. 3 shows the burn patty test results of the 3 formulations of Examples 2-4, coated at a lower thickness (Meyer rod 12 thickness) in a 450 burn using the formulations listed in Table 5 with the emulsions described in Table 2. The only major difference between the three examples was the inclusion of monomer (c) non-cationic nitrogen-containing monomer in Example 3, and monomer (a) carboxylic acid-functional (meth)acrylate short chain ester monomer or oligomer thereof in Example 4. These monomers contributed to a reduced burn area and more effective fire retardancy with the same loading of flame retardant agent OP935. Notice the reduced burn area of Examples 3 and 4 with similar loadings of BA and IOA, and only the small addition of the (a) and (c) classes of monomers to improve the fire retardancy in a noticeable degree as seen by a lower height of burn and slightly more narrow area.

TABLE 8

| | | Burn | | | | | | | | | | |
|---|---|---|---|---|---|---|---|---|---|---|---|---|
| | Coat | Width | Height | OLS | | | 4- | | | | | |
| Examples | Thickness | (cm) | (cm) | (min) | BA | IOA | HBA | NVC | BCEA | VA | MAA | Quat |
| Ex-5 | M12 | 19.2 | 24.4 | 2803 | 87.8 | 0 | 0 | 2 | 2 | 5 | 2 | 1 |
| (COMP) | | | | | | | | | | | | |
| Ex-6 | M12 | 14.9 | 21.2 | 4 | 85.9 | 0 | 2 | 0 | 6 | 5 | 2 | 1 |
| (COMP) | | | | | | | | | | | | |
| Ex-7 | M12 | 17.1 | 19.7 | 3253 | 79.9 | 0 | 6 | 6 | 0 | 5 | 2 | 1 |
| Burn | | | | | | | | | | | | |
| Comments: | | | | | | | | | | | | |

| | |
|---|---|
| Ex-5 | wide and tall, little residual PET |
| (COMP) | |
| Ex-6 | narrow, low flame temp, significant residual PET |
| (COMP) | |
| Ex-7 | more narrow, lower flame temp, significant residual PET |

FIG. 4 shows the burn test results from 450 burn, showing the larger burn area for Example 5 (monomers (a), (c), and (d), but no monomer (b)) as compared to Example 6 (monomers (a), (b), and (d), but no monomer (c)) and Example 7 (monomers (a), (b), (c), and (d)). Full formulations for burns are described in Table 5 with the emulsions described in Table 2. Notice here the addition of monomer (b) in Examples 6 and 7 provided decreased burn width and heights in both samples and a much narrow “v” in the bottom of the burn sample indicating a lower degree of flame spreading.

TABLE 9

| | | Burn | | | | | | | | | | | |
|---|---|---|---|---|---|---|---|---|---|---|---|---|---|
| | Coat | Width | Height | OLS | | | | | | T- | | | |
| Examples | Thickness | (cm) | (cm) | (min) | BA | IOA | 4-HBA | NVC | BCEA | 8Acm | VA | MAA | Quat |
| Ex-8 | M12 | 12.8 | 15.2 | 10K | 83.9 | 0 | 2 | 4 | 4 | 0 | 5 | 0 | 1 |
| Ex-9 | M12 | 11.9 | 16.6 | 871 | 73.82 | 10 | 2 | 2 | 6 | 0 | 5 | 0 | 1 |
| Ex-10 | M12 | 17.4 | 19.1 | 10K | 45.8 | 42 | 4 | 2 | 2 | 0 | 2 | 2 | 1 |
| Ex-11 | M12 | 14.6 | 18.1 | 2520 | 77.9 | 0 | 2 | 0 | 4 | 10 | 5 | 0 | 1 |
| Ex-12 | M12 | 21.3 | 21.2 | — | — | — | — | — | — | — | — | — | — |
| (COMP) | | | | | | | | | | | | | |
| Ex-13 | M12 | 19.4 | 17.4 | — | — | — | — | — | — | — | — | — | — |
| (COMP) | | | | | | | | | | | | | |
| Burn | | | | | | | | | | | | | |
| Comments: | | | | | | | | | | | | | |

| | |
|---|---|
| Ex-8 | Narrow width, short burn, low temp, high residual PET across burned area |
| Ex-9 | Narrow width, short burn, low temp, high residual PET across burned area, near edges almost no burning just melting of PET |
| | layers |
| Ex-10 | medium width medium height burn, low temp, high residual PET across burned area |
| Ex-11 | narrow width medium height burn, low temp, high residual PET across burned area |
| Ex-12 | Broad wide burn, lingering flame along edge, nearly fully consumed PET across burn area |
| (COMP) | |
| Ex-13 | Broad wide burn, nearly fully consumed PET across burn area, little char even to edge of burn area |
| (COMP) | |

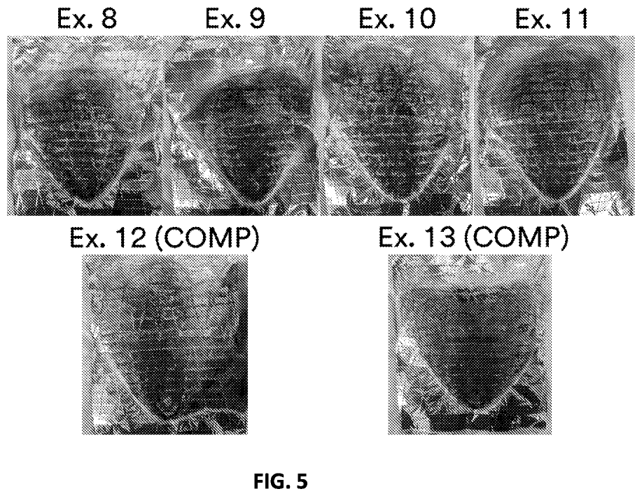

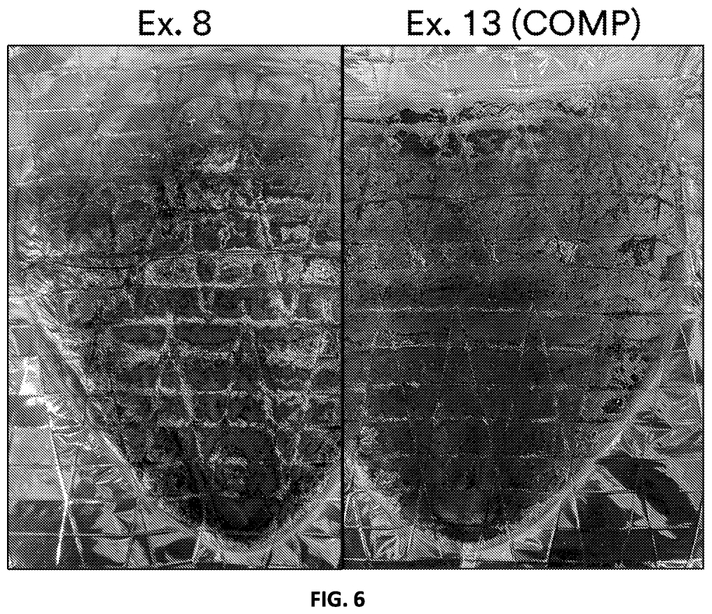

FIG. 5 shows the burn test results from 450 burn. All samples were made at the same solids level and coated under the same Meyer rod for similar thicknesses. Full formulations for burns are described in Table 5 with the emulsions described in Table 2.

Note the commercial emulsions were diluted with water to ensure the polymer solids to flame-retardant agent were about the same across all test samples. The difference in burn resistance is clear between the Examples 8-11 as compared to Examples 12 and 13. Whereas the commercial emulsions in Examples 12 and 13 burned most of the test sheet area and left little to no residual PET in the burned area (indicating a hot burn region), Examples 8-11 demonstrate that the selected monomers used in the PSA's of the present disclosure dramatically reduced the burn area under the same flame-retardant agent loading, and provided a high residual PET in the burn area (indicating a low burn temperature region) with lots of black char in the upper regions of the unburned sample.

FIG. 6 is a close-up image showing the significant difference in unburned/residual PET in the burn zone of Example 8 as compared to near complete burn of the PET in commercial sample Example 13. This is evidenced by the residual bright metallic PET segments scattered across Example 8 burn area, whereas Example 13 has little to no residual PET and inside the burn are there is nearly full combustion of the PET and adhesive layers with little to no char formed. This clearly demonstrates the effectiveness of the selection of monomers to dramatically improve the effectiveness of the same loading of flame-retardant agent.

The complete disclosures of the patents, patent documents, and publications cited herein are incorporated by reference in their entirety as if each were individually incorporated. To the extent that there is any conflict or discrepancy between this specification as written and the disclosure in any document that is incorporated by reference herein, this specification as written will control. Various modifications and alterations to this disclosure will become apparent to those skilled in the art without departing from the scope and spirit of this disclosure. It should be understood that this disclosure is not intended to be unduly limited by the illustrative embodiments and examples set forth herein and that such examples and embodiments are presented by way of example only with the scope of the disclosure intended to be limited only by the claims set forth herein as follows.

1. A fire-retardant pressure sensitive adhesive comprising:
a (meth)acrylate polymer comprising interpolymerized monomers comprising:
(a) an acid-functional (meth)acrylate monomer or oligomer thereof;
(b) a hydroxy-functional (meth)acrylate monomer or oligomer thereof;
(c) a non-cationic nitrogen-containing monomer or oligomer thereof, wherein the non-cationic nitrogen-containing monomer is selected from the group consisting of N-vinyl caprolactam, N-vinyl pyrrolidinone, acrylonitrile, dimethyl acrylamide, acrylamide, t-octyl acrylamide, and a combination thereof; and
(d) a (meth)acrylate ester of a linear or branched alcohol having 3 to 4 carbon atoms and/or a (meth)acrylate ester of a linear, branched, or cyclic alcohol having 5 to 20 carbon atoms; and
a non-halogenated flame retardant.

2. The adhesive of claim 1 wherein the acid-functional (meth)acrylate monomer is selected from the group consisting of methacrylic acid, acrylic acid, and a combination thereof.

3. The adhesive of claim 1 wherein the acid-functional (meth)acrylate monomer is selected from a carboxylic acid-functional (meth)acrylate short chain ester monomer or oligomer thereof.

4. The adhesive of claim 3 wherein the carboxylic acid-functional (meth)acrylate short chain ester monomer or oligomer thereof is selected from the group consisting of beta-carboxy ethyl acrylate, 2-methacryloyloxyethyl succinate, fumaric acid, an oligomer thereof, and a combination thereof.

5. The adhesive of claim 1, wherein the hydroxy-functional (meth)acrylate monomer is selected from the group consisting of 4-hydroxy butyl acrylate, 2-hydroxy ethyl acrylate, hydroxy propyl acrylate, an oligomer thereof, and a combination thereof.

6. The adhesive of claim 1, wherein the interpolymerized monomers comprise at least 0.1 part of the acid-functional (meth)acrylate monomer, based on the total amount of the interpolymerized monomers.

7. The adhesive of claim 1, wherein monomers (a), (b), and (c) are present in a combined amount of at least 8 parts and up to 30 parts, based on the total amount of the interpolymerized monomers.

8. The adhesive of claim 1, wherein the interpolymerized monomers comprise the (meth)acrylate ester of the linear or branched alcohol having 3 to 4 carbon atoms.

9. The adhesive of claim 8 wherein the interpolymerized monomers comprise 40 parts to 95 parts of the (meth)acrylate ester of a linear or branched alcohol having 3 to 4 carbon atoms, based on the total amount of interpolymerized monomers.

10. The adhesive of claim 1, wherein the interpolymerized monomers comprise the (meth)acrylate ester of the linear, branched, or cyclic alcohol having 5 to 20 carbon atoms.

11. The adhesive of claim 10 wherein the interpolymerized monomers comprise 10 parts to 60 parts of the (meth)acrylate ester of a linear, branched, or cyclic alcohol having 5 to 20 carbon atoms, based on the total amount of interpolymerized monomers.

12. The adhesive of claim 1, wherein the non-halogenated flame retardant comprises a phosphorus-containing compound, a borate, an inorganic metal-containing compound, a char former, a clay, a graphite, a silicate, or a combination thereof.

13. The adhesive of claim 12 wherein the non-halogenated flame retardant comprises a phosphorus-containing compound.

14. The adhesive of claim 13 wherein the phosphorus-containing compound is selected from the group consisting of ammonium pyrophosphate, ammonium polyphosphate, diethyl phosphinate, ethylene diamine phosphate, melamine pyrophosphate, melamine polyazine phosphate, melamine polymagnesium phosphate, melamine zinc phosphate, piperazine phosphate, pyrophosphoric acid salt, 9,10-dihydro-9-oxa-10-phosphaphenanthrene 10-oxide, hydroxyphenyl phosphinyl propanoic acid, red phosphorus, triphenyl phosphine oxide, and a combination thereof.

15. The adhesive of claim 1, wherein the non-halogenated flame retardant is present in an amount of 0.1 wt-% to 30 wt-%, based on the total weight of the fire-retardant pressure sensitive adhesive.

16. The adhesive of claim 1, further comprising water.

17. A fire-retardant pressure sensitive adhesive comprising:
a (meth)acrylate polymer comprising interpolymerized monomers comprising:
(a) 0.1 part to 30 parts of methacrylic acid, acrylic acid, or a combination thereof and/or 0.1 part to 30 parts of beta-carboxy ethyl acrylate, 2-methacryloyloxyethyl succinate, fumaric acid, an oligomer thereof, or a combination thereof;
(b) 0.1 part to 20 parts of 4-hydroxy butyl acrylate, 2-hydroxy ethyl acrylate, hydroxy propyl acrylate, an oligomer thereof, or a combination thereof;
(c) 0.1 part to 8 parts of N-vinyl caprolactam, N-vinyl pyrrolidinone, acrylonitrile, dimethyl acrylamide, acrylamide, t-octyl acrylamide, or a combination thereof;
(d) 40 parts to 95 parts of n-propyl(meth)acrylate, isopropyl(meth)acrylate, n-butyl(meth)acrylate, isobutyl(meth)acrylate, tert-butyl(meth)acrylate, or a combination thereof, and/or 10 parts to 60 parts of n-pentyl(meth)acrylate, iso-pentyl(meth)acrylate, n-hexyl(meth)acrylate, iso-hexyl(meth)acrylate, cyclohexyl(meth)acrylate, phenyl(meth)acrylate, 1-octyl(meth)acrylate, iso-octyl(meth)acrylate, 2-octyl(meth)acrylate, 3-octyl(meth)acrylate, 2-ethylhexyl(meth)acrylate, decyl(meth)acrylate, lauryl(meth)acrylate, 2-propylheptyl(meth)acrylate, stearyl(meth)acrylate, isobornyl(meth)acrylate, benzyl(meth)acrylate, octadecyl (meth)acrylate, nonyl(meth)acrylate, dodecyl(meth)acrylate, isophoryl(meth)acrylate, or a combination thereof;
wherein the amount of each monomer in parts is based on the total amount of the interpolymerized monomers, and the total amount of interpolymerized monomers includes 100 parts; and
a non-halogenated flame retardant.

18. An adhesive article comprising a first adhesive layer disposed on a first surface of a supporting layer, wherein the first adhesive layer comprises the fire-retardant pressure sensitive adhesive of claim 1.

19. The fire-retardant pressure sensitive adhesive of claim 1, wherein the interpolymerized monomers further comprise a cationic monomer.

20. A flexible ductwork comprising the adhesive article of claim 18.
